(19) United States
(12) Patent Application Publication
(10) Pub. No.: US 2011/0128446 A1
(43) Pub. Date: Jun. 2, 2011

(54) CAR AUDIO/VIDEO TERMINAL SYSTEM HAVING USER INTERFACE LINKABLE WITH PORTABLE DEVICE AND METHOD FOR LINKING THE SAME

(75) Inventor: Keun Sang Woo, Suwon (KR)

(73) Assignee: HYUNDAI MOTOR COMPANY, Seoul (KR)

(21) Appl. No.: 12/754,757

(22) Filed: Apr. 6, 2010

(30) Foreign Application Priority Data
Nov. 27, 2009 (KR) 10-2009-0115654

(51) Int. Cl. H04N 7/00; H04N 5/64; G06F 3/041

(52) U.S. Cl. 348/552; 348/837; 345/173; 348/E07.001; 348/E05.128

(57) ABSTRACT

The present invention features a car audio/video (AV) terminal system having a user interface that is linkable with a portable device and a method for linking the same, where the system can implement the same user interface of a portable device, including the external appearance, in a car AV terminal.

### CROSS-REFERENCE TO RELATED APPLICATION

This application claims under 35 U.S.C. §119(a) the benefit of Korean Patent Application No. 10-2009-115654, filed on Nov. 27, 2009 in the Korean Intellectual Property Office, the disclosure of which is incorporated herein in its entirety by reference.

### BACKGROUND OF THE INVENTION

1. Field of the Invention

The present invention relates to a car audio/video (AV) terminal system, and more particularly, to a car AV terminal system having a user interface linkable with a portable device and a method for linking the same, which can implement the same user interface as that including an external appearance of a portable device and a user interface of the portable device in a car AV terminal.

2. Background Art

Presently, most cars support MP3 and USB, and a user can listen to MP3 music by connecting a portable MP3 player to a car AV terminal.

However, since only basic functions, for example such as “PLAY”, “STOP”, “FF”, “REW”, “VOL+”, “VOL−”, of a portable device can be used, it is not possible to use special functions, such as “SETUP” and “PHONE”, for example.

When using the special functions of a portable device, it is required to separately select a protocols of each of the respective devices/functions. For example, in the case of performing a Bluetooth function of a portable phone in an audio/video navigation (AVN) terminal and in the case of performing a game of the cellular phone in the AVN terminal, the protocols by devices/functions should be separately selected.

Further, the utilization method of the portable device is different from the utilization method of the AVN provided in a vehicle, and thus in the case of performing the Bluetooth function of the portable phone in the AVN, a user has to learn the separate functions of each device, which can be an inconvenience in use.

U.S. Patent Application Publication No. 2009-0209198, incorporated by reference in its entirety herein, is directed to a remote resource access interface apparatus which receives resolution information and key information from an external device (i.e. a portable device) as information for setting a connection with the portable device and displays a user interface, as a method for accessing resources of the portable device.

Japanese Patent Unexamined Publication No. 2004-322475, incorporated by reference in its entirety herein, is directed to a printing device linkable with an image pickup device, which displays a user interface that is identical to a user interface of the image pickup device and performs printing of an instruction related to a print output of the image pickup device using the user interface that is identical to the user interface of the image pickup device displayed on the printing device.

On the other hand, AV devices for vehicles may be implemented in suitably diverse forms, for example, the devices may be provided with diverse hard keys in kind and number. Further, diverse kinds of multimedia devices are connected to vehicles, and the number of such multimedia devices to be connected to the vehicles is continuously increasing. Thus, there remains a need in the art to newly configure the user interfaces and key arrangements for the respective multimedia devices.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a car audio/video (AV) terminal system having a user interface linkable with a portable device and a method for linking the same, which can suitably implement the same user interface as that including an external appearance of a portable device and a user interface of the portable device in a car AV terminal.

The present invention, in other aspects, also provides a car audio/video (AV) terminal system having a user interface linkable with a portable device and a method for linking the same, which require no change of a user interface and a key arrangement in an AV terminal for respective multimedia devices, and require no establishment of separate protocols for respective multimedia devices/functions.

In preferred embodiments, the present invention provides a car audio/video (AV) terminal system having a user interface linkable with a portable device suitably connected to the system, which includes an AV terminal connected to the portable device for suitably receiving a portable device image from the portable device, suitably outputting the portable device image to an AV screen, suitably transmitting a touch manipulation value to the portable device if a user touches the AV screen, suitably outputting an image corresponding to the operation of the portable device to the AV screen, and suitably outputting sound corresponding to the operation of the portable device to a speaker provided in a vehicle; and a portable device connected to the AV terminal through a wired/wireless interface for analyzing the touch manipulation value transmitted from the AV terminal to operate accordingly and transmitting the sound and the image corresponding to the operation of the portable device to the AV terminal; wherein the image output from the portable device preferably includes a shape of an external appearance of the portable device, and the AV terminal implements the user interface corresponding to the external appearance of the portable device on the AV screen.

In certain preferred embodiments, the AV terminal may include a touch screen displaying the AV screen of the AV terminal and executing the touch manipulation; a mode setting unit setting an operation mode of the AV terminal; a data processing unit converting the sound and the image transmitted from the portable device into a form that matches the AV terminal; and a memory storing ID information corresponding to a device name of the AV terminal.

In certain preferred embodiments, the AV terminal may further include a vibration generating unit operating vibration feedback by operating a motor when the user performs the touch manipulation.

In certain preferred embodiments, the AV terminal may automatically enter into a portable device mode when the AV terminal is connected to the portable device.

In certain preferred embodiments, the AV terminal may transmit ID information that corresponds to a device name of the AV terminal to the portable device.

Preferably, the portable device may include a database (DB) searching for a set value that corresponds to the ID information of the AV terminal.

In further exemplary embodiments, the ID information may preferably include a company name, a vehicle type, year, a system type, or software version, and the set value may preferably include resolution of the AV terminal, a standard output sound, or a touch coordinate correction value.

In another preferred embodiment of the present invention, there is provided a method for linking a user interface of a vehicle audio/video (AV) terminal with a portable device, which preferably includes a) operating an AV terminal for vehicle and suitably connecting the AV terminal with a portable device; b) suitably outputting an image of an external appearance of the portable device by the portable device; c) outputting the portable device image to an AV screen by the AV terminal; d) touching the AV screen by a user and suitably transmitting a touch manipulation value from the AV terminal to the portable device; e) suitably analyzing the transmitted touch manipulation value by the portable device and operating the portable device accordingly; f) suitably transmitting sound and an image corresponding to the operation of the portable device to the AV terminal by the portable device; and g) suitably outputting the transmitted portable device image to the AV screen by the AV terminal and outputting the transmitted portable device sound through a speaker.

In the method according to a preferred embodiment of the present invention, if the AV terminal is suitably connected with the portable device in the step a), the AV terminal may automatically enter into a portable device mode.

In the method according to another preferred embodiment of the present invention, in the step b), the image of the external appearance of the portable device output by the portable device may include buttons of the portable device.

In the method according to still another preferred embodiment of the present invention, in the step c), the AV terminal may suitably transmit ID information that corresponds to a device name of the AV terminal to the portable device.

In the method according to another preferred embodiment of the present invention, the portable device may search for a set value that corresponds to the ID information of the AV terminal in a database (DB).

In the method according to still another preferred embodiment of the present invention, the ID information may include a company name, a vehicle type, year, a system type, or software version, for example, and the set value may include resolution of the AV terminal, a standard output sound, or a touch coordinate correction value.

In the method according to another preferred embodiment of the present invention, in the step d), the AV terminal may operate vibration feedback by operating a motor when the user performs the touch manipulation.

In the method according to another preferred embodiment of the present invention, the steps b) to g) may be repeatedly performed.

According to another preferred embodiment of the present invention, a user interface that is the same as that including an external appearance of a portable device and a user interface of the portable device is suitably implemented in a car AV terminal, and thus a user convenience can be improved. That is, according to further related embodiments, a user can use the user interface (UI) and the keys of the existing multimedia appliance that is most familiar to the user as they are.

According to certain preferred embodiments of the present invention, it is not required to change the user interface and the key arrangement in a headset unit (H/U) for the respective multimedia devices, and also it is not required to suitably establish separate protocols for the respective multimedia devices/functions. Accordingly, the design of the AV terminal according to preferred embodiments of the present invention is facilitated.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating the configuration of an exemplary car AV terminal having a user interface linkable with a portable device according to an embodiment of the present invention;

FIG. 2 is a block diagram illustrating a schematic configuration of a car AV terminal having a user interface linkable with a portable device according to an embodiment of the present invention;

FIG. 3 is an operation flowchart illustrating an exemplary method of liking a user interface of a car AV terminal with a portable device according to an embodiment of the present invention;

FIG. 4 is a diagram exemplifying detailed operations in a method of liking a user interface of a car AV terminal with a portable device according to an embodiment of the present invention;

FIG. 5 is a diagram exemplifying a touch signal transmission in an exemplary method of linking a user interface of a car AV terminal with a portable device according to an embodiment of the present invention;

FIGS. 6 to 8 are diagrams illustrating examples of a user interface of an AV terminal according to an embodiment of the present invention;

FIG. 9 is a diagram exemplifying an ID of a portable device that is set in an AV terminal according to an embodiment of the present invention; and

FIG. 10 is a diagram illustrating the settings for each ID of a portable device that is stored in a portable device according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

As described herein, the present invention includes a car audio/video (AV) terminal system having a user interface linkable with a portable device connected to the system, comprising an AV terminal connected to the portable device for receiving a portable device image from the portable device, and a wired/wireless interface that connects the portable device to the AV terminal, wherein the image output from the portable device includes a shape of an external appearance of the portable device, and the AV terminal implements a user interface corresponding to the external appearance of the portable device on the AV screen.

In one embodiment, the AV terminal outputs the portable device image to an AV screen, transmits a touch manipulation value to the portable device if a user touches the AV screen, outputs an image corresponding to the operation of the portable device to the AV screen, and outputs a sound corresponding to the operation of the portable device to a speaker provided in a vehicle.

In another embodiment, the portable device connected to the AV terminal through the wired/wireless interface is used for analyzing the touch manipulation value transmitted from the AV terminal to operate accordingly and transmitting the sound and the image corresponding to the operation of the portable device to the AV terminal.

The present invention also includes a method for linking a user interface of a vehicle audio/video (AV) terminal with a portable device, comprising the steps of a) operating an AV terminal for a vehicle and connecting the AV terminal with a portable device, b) outputting an image of an external appearance of the portable device by the portable device, c) outputting the portable device image to an AV screen by the AV terminal, d) touching the AV screen by a user and transmitting a touch manipulation value from the AV terminal to the portable device, e) analyzing the transmitted touch manipulation value by the portable device and operating the portable device accordingly, f) transmitting sound and an image corresponding to the operation of the portable device to the AV terminal by the portable device, and g) outputting the transmitted portable device image to the AV screen by the AV terminal and outputting the transmitted portable device sound through a speaker.

Hereinafter, preferred embodiments of the present invention will be described in greater detail with reference to the accompanying drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail. In the following description, the same reference numerals are used for the same elements even in different drawings.

In the following description of the present invention, the term “comprises” and/or “comprising” used in the description means that one or more other components and/or existence or addition of elements are not excluded in addition to the described components and/or elements unless specially described. Also, the term “unit”, as used therein, means a unit that performs at least one function or operation, and may be implemented by hardware, software, or a combination thereof.

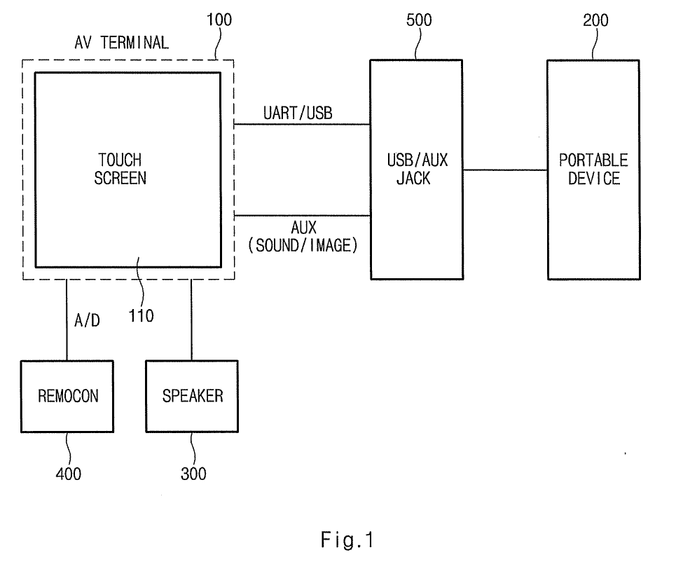

FIG. 1 is a diagram illustrating the preferred configuration of a car AV terminal having a user interface linkable with a portable device according to a preferred embodiment of the present invention.

In one exemplary embodiment, and referring to FIG. 1 for example, a car AV terminal system having a user interface linkable with a portable device preferably includes an AV terminal 100, a portable device 200, a speaker 300, a remote controller 400, and an interface terminal (e.g. USB/AUX jack) 500.

Preferably, the AV terminal 100 includes a monitor having a vibration feedback function, i.e. a touch screen 110, and may be connected to the remote controller 400 or the speaker 300.

According to certain preferred embodiments, the portable device 200 is in wired/wireless connection with the AV terminal 100 through the interface terminal 500 including the USB/AUS jack to be linked with each other. For example, in certain preferred embodiments, a touch signal may be suitably transferred through UART/USB terminals, and an audio/video signal may be suitably transferred through an AUX jack.

Accordingly, in certain preferred embodiments, the AV terminal 100 receives information (including external appearance information of the portable device) for generating a user interface from the portable device 200 to generate the user interface, and the AV terminal 100 generates a user interface (UI) on the touch screen 110 so as to provide the same user interface including the external appearance of the portable device 200. In preferred embodiments, the user interface (UI) includes a graphic user interface (GUI).

In certain preferred embodiments, according to the car AV terminal system having a user interface linkable with a portable device and a method for linking the same, when the car AV terminal 110 and the portable device 200 are suitably linked together, the portable device 200 suitably transmits user interface information which includes a manipulation image that is the same as the external appearance of the portable device and a screen image to the AV terminal 100, and the AV terminal 100 displays the transmitted user interface information on the touch screen 110 that is an AV screen. Preferably, if a user manipulates a touch as if the user actually manipulates the portable device 200, the corresponding touch signal is suitably transmitted to the portable device 200 to control the portable device.

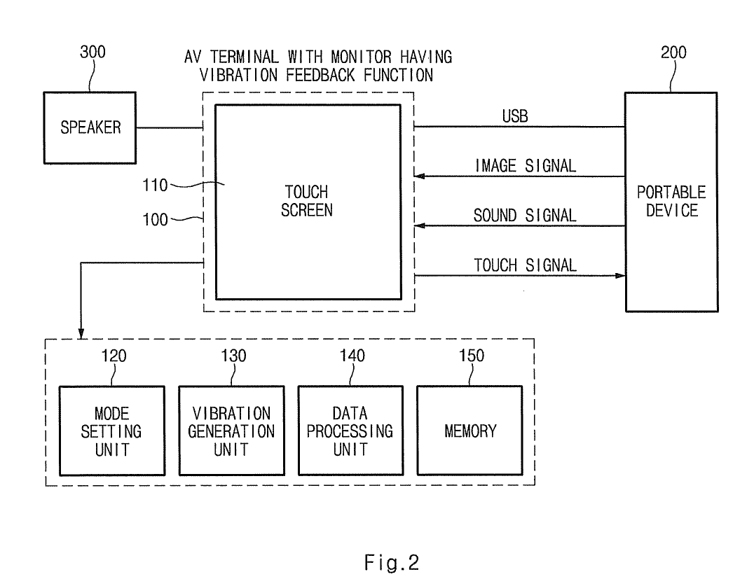

In further exemplary embodiments, for example as shown in FIG. 2, FIG. 2 is a block diagram illustrating the schematic configuration of a car AV terminal having a user interface linkable with a portable device according to a preferred embodiment of the present invention.

Referring to FIG. 2, in a car AV terminal system having a user interface linkable with a portable device, an AB terminal 100 preferably includes, but is not limited to, a touch screen 110, a mode setting unit 120, a vibration generation unit 130, a data processing unit 140, and a memory 150.

Preferably, the AV terminal 100 includes a monitor having a vibration feedback function, i.e. the touch screen 110, and is linked with the portable device 200, so that the AV terminal 100 receives a portable device image from the portable device 200, and suitably transmits the portable device image to the touch screen 110 that is the AV screen. Preferably, if a user touches the touch screen, the AV terminal 100 suitably transmits a touch manipulation value to the portable device 200, suitably transmits an image corresponding to the operation of the portable device 200 to the touch screen 110, and suitably outputs sound corresponding to the operation of the portable device 200 to the speaker provided within the vehicle.

In further preferred embodiments, the portable device 200 is suitably connected to the AV terminal 100 through a wired/wireless interface, analyzes the touch manipulation value transmitted from the AV terminal 100 to operate corresponding to the result of analysis, and suitably transmits the sound and image corresponding to the operation of the portable device 200 to the AV terminal 100. Preferably, the image output from the portable device 200 includes an external appearance of the portable device 200.

In further preferred embodiments, the AV terminal 100 suitably transmits ID information corresponding to the device name of the AV terminal to the portable device 200, and the portable device 200 preferably includes a database DB for searching for a set value corresponding to the ID information of the AV terminal 100. In certain preferred embodiments, the ID information may include, but is not limited to, a company name, a vehicle type, year, a system type, or software version, and the set value may include, but is not limited to, resolution of the AV terminal, a standard output sound, or a touch coordinate correction value.

In particularly preferred embodiments, the touch screen 110 of the AV terminal 100 displays the AV screen of the AV terminal 100, and executes the touch manipulation.

Preferably, the mode setting unit 120 sets an operation mode of the AV terminal 100. For example, if the Av terminal 100 is connected to the portable device 200, it automatically enters into a portable device mode.

In further preferred embodiments, the vibration generation unit 130 operates a vibration feedback by suitably rotating a motor when a user performs a touch manipulation.

Preferably, the data processing unit 140 converts the sound and image transmitted from the portable device 200 into a form that matches the AV terminal 100.

In further preferred embodiments, the memory 150 stores ID information corresponding to the device name of the AV terminal 100.

In preferred embodiments of the present invention, an image signal transmitted from the portable device 200 includes an external appearance (including buttons) of the portable device 200 and a user interface (UI) that is displayed on an LCD screen of the portable device 200. In particular preferred embodiments, the user interface that is changed on the LCD screen of the portable device 200 is suitably transferred to the AV terminal 100 in real time.

Further, a sound signal output from the portable device 200 (e.g. music, movie sound, manipulation sound of the portable device, and the like) is suitably transmitted to the AV terminal 100 in real time, and is output through a speaker 300 provided in the vehicle.

Preferably, a touch signal that is suitably output when a user manipulates the touch screen 110 of the AV terminal 100 is transmitted to the portable device 200, and in certain preferred embodiments, the touch signal that is transmitted to the portable device 200 is the same as the touch signal that is used in the AB terminal 100.

Accordingly, in the car AV terminal system with a user interface linkable with the portable device according to preferred embodiments of the present invention, the AV terminal 100 can suitably implement the user interface that corresponds to the external appearance of the portable device 200 on the touch screen 110 that is the AV screen.

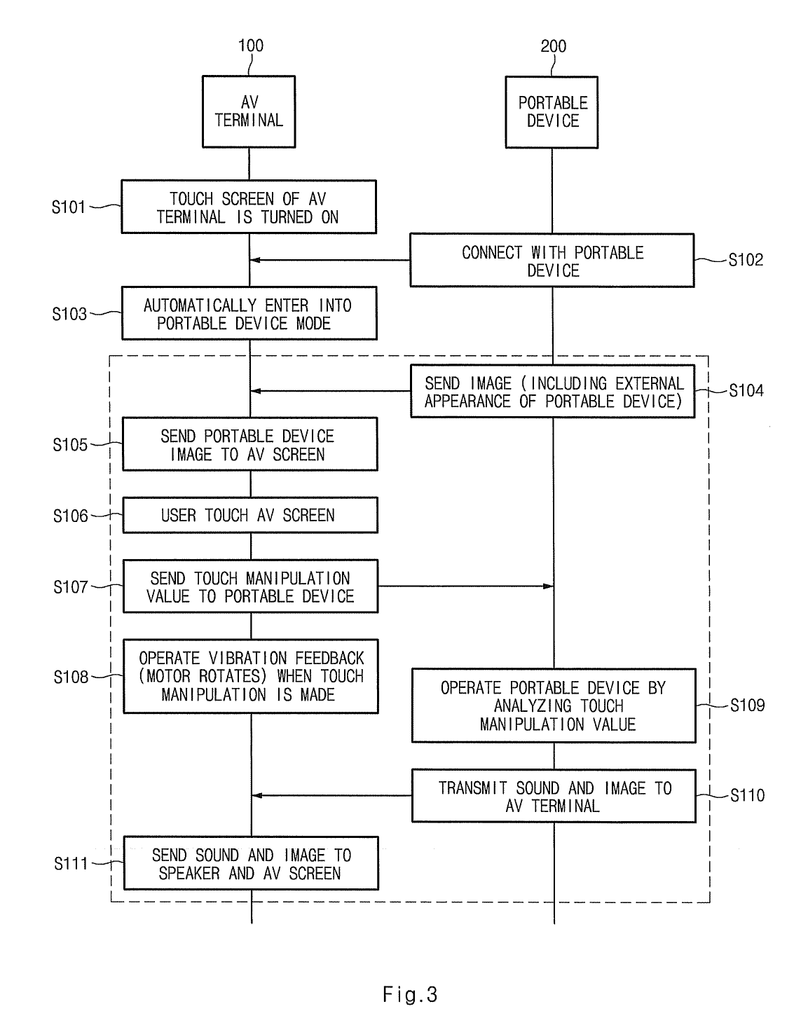

According to certain exemplary embodiments and as shown in FIG. 3, for example, FIG. 3 is an operation flowchart illustrating a method of linking a user interface of a car AV terminal with a portable device.

Referring to FIG. 3, according to a method of linking a user inter interface of a car AV terminal with a portable device according to an exemplary embodiment of the present invention, the car AV terminal 100 is suitably connected to the portable device 200 (step S102) after the AV terminal 100 is operated.

Preferably, when the AV terminal 100 is connected to the portable device 200, the AV terminal 100 automatically enters into a portable device mode (step S103).

In further preferred embodiments, the portable device 200 outputs an image that includes an external appearance (including bottoms) of the portable device 200 to the AV terminal 100 (step S104).

Further, the AV terminal 100 suitably outputs the portable device image to the touch screen 110 that is the AV screen (S105). Preferably, in this case, the AV terminal 100 suitably transmits ID information corresponding to the device name of the AV terminal 100 to the portable device 200. In response to this, the portable device 200 searches for a set value that corresponds to the ID information of the AV terminal 100 in a DB of the portable device 200. Accordingly, the ID information may preferably include a company name, a vehicle type, year, a system type, or software version, and the set value may include resolution of the AV terminal, a standard output sound, or a touch coordinate correction value.

Preferably, if a user manipulates the touch screen 110 by touching the same (step S106), the AV terminal 100 transmits the touch manipulation value to the portable device 200 (step S107). Preferably, in accordance with the user's touch manipulation, the AV terminal operates a vibration feedback by rotating a motor (step S108).

According to further preferred embodiments, the portable device 200 analyzes the transmitted touch manipulation value, and suitably operates the portable device 200 according to the result of analysis (step S109).

Further, the portable device 200 suitably transmits sound and an image that correspond to the operation of the portable device 200 to the AV terminal 100 (step S110).

In further preferred embodiments, the AV terminal 100 sends the image of the portable device 200 to the touch screen 110, and outputs the sound of the portable device 200 through the speaker 300 (step S111). In related embodiments, subsequently, the steps S104 to S111 are repeatedly performed.

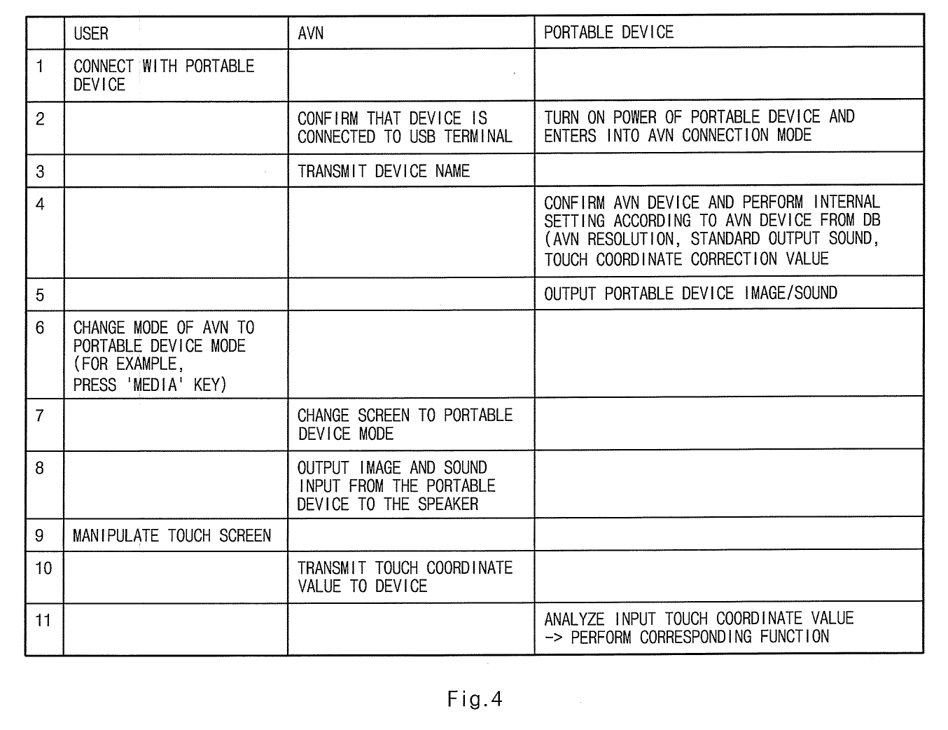

FIG. 4 is a diagram exemplifying detailed operations in a method of liking a user interface of a car AV terminal with a portable device according to other exemplary embodiments of the present invention.

Referring to FIG. 4, the AV terminal is preferably an AVN (Audio Video Navigation). Preferably, if a user connects the portable device to the AVN, the AVN 100, for example, confirms whether the portable device is suitably connected to a USB terminal, and at this time, if the power of the portable device 200 in a turned-on state, the portable device 200 enters into an AVN connection mode.

Further, if the AVN 100 transmits the device name, i.e. the ID to the portable device 200, the portable device 200 searches for the device name of the AVN 100 in the DB of the portable device 200, and set internal set values. For example, in further related embodiments, the portable 200 sets AVN resolution, standard output sound, a touch coordinate correction value, or the like. In further related embodiments, the portable device 200 transmits an image and sound corresponding to the operation of the portable device.

In other further embodiments, if a user changes the mode of the AVN 100 to a portable device mode (e.g. if a user presses a MEDIA key), the AVN 100 suitably changes its display screen to the portable device mode, and suitably outputs the image and sound input from the portable device 200 through the touch screen and the speaker, respectively.

Accordingly, if the user manipulates the touch screen, the AVN 100 suitably transmits the touch coordinate value to the portable device 200, and thereafter, the portable device 200 analyzes the input touch coordinate value and performs the corresponding function.

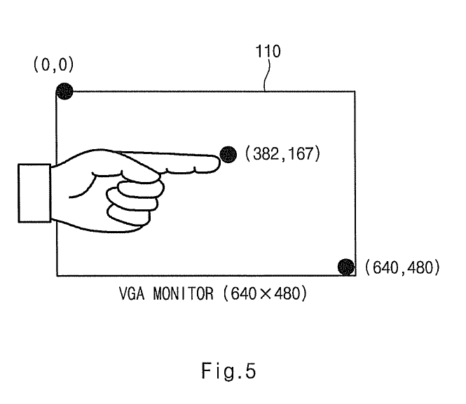

According to certain exemplary embodiments and as shown in FIG. 5, for example, FIG. 5 is a diagram exemplifying a touch signal transmission in a method of liking a user interface of a car AV terminal with a portable device.

As illustrated in FIG. 5, in the case in which the touch is transmitted through a VGA monitor (having resolution of 640×480), one of 307,200 signals (0,0), (0,1), (0,2), . . . , (640,480) may be transmitted, for example, for 0.1 second in a period of 10 Hz. However, since the touch coordinates and the touch position intended by a user may differ for each AVN device, a touch coordinate correction value may be adopted.

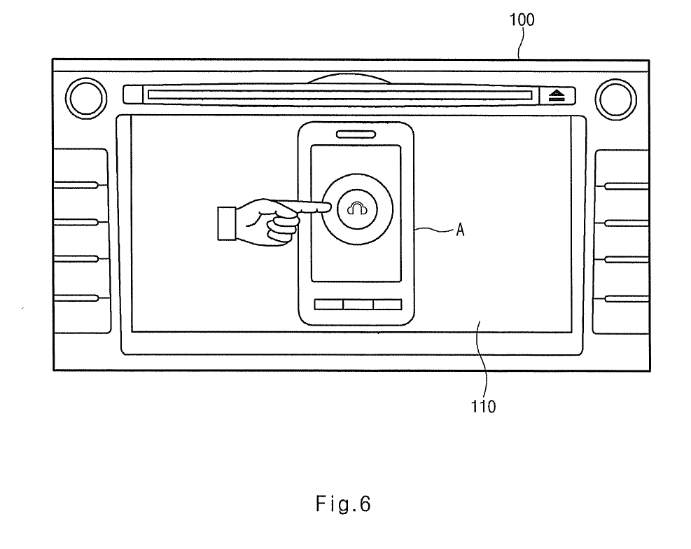

FIGS. 6 to 8 are views exemplifying a user interface screen of the AV terminal according to further exemplary embodiments of the present invention.

In certain exemplary embodiments, if the portable device displayed on the AV terminal 100 is, for example, a latest “Haptic” phone, for example as illustrated as a reference numeral “A” in FIG. 6, the same manipulation method as the “Haptic” phone manipulation method may be used in manipulating the touch screen.

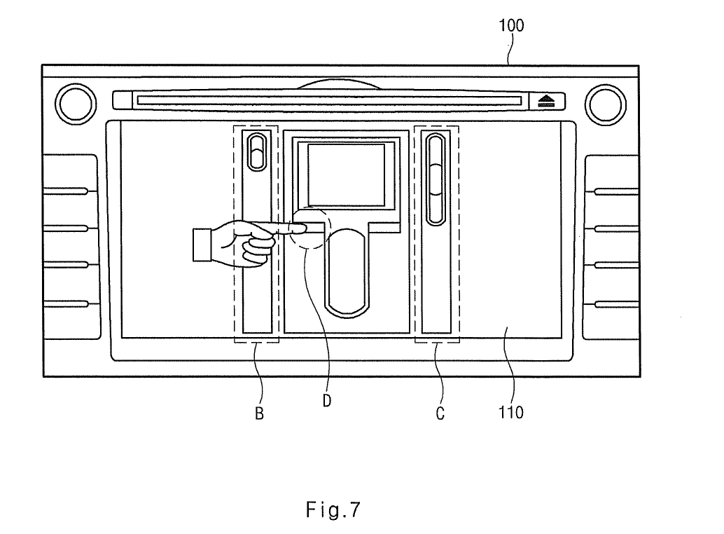

Further, according to an example of a user interface screen of the AV terminal as shown in FIG. 7, buttons are displayed, as indicated as the reference numeral D in FIG. 6, on left and right sides of a multimedia device that is displayed on the AV terminal 100 according to an embodiment of the present invention.

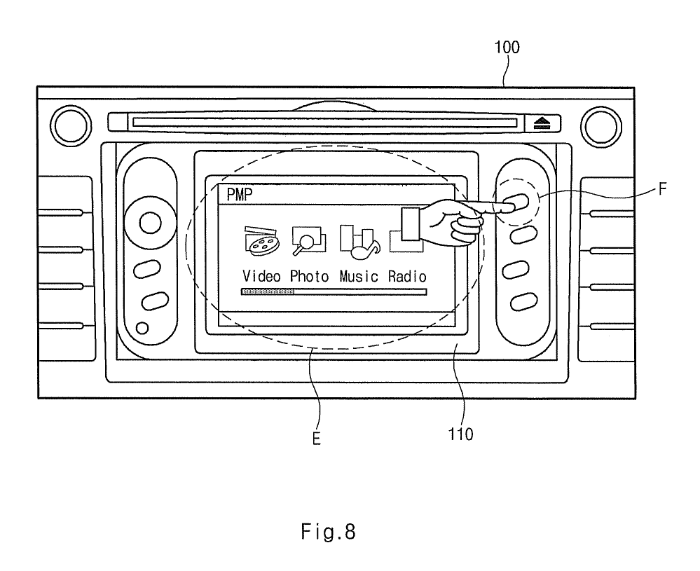

Preferably, as shown as the reference numeral D in FIG. 8, the same user interface (UI) as the multimedia device is suitably implemented on the AV terminal 100 according to an embodiment of the present invention. In this example, a touch button as indicated as the reference numeral “F” is implemented on the EH touch screen 110 together with the multimedia device.

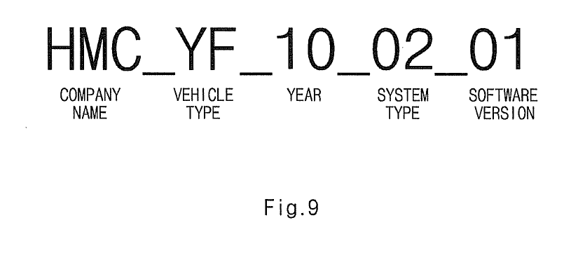

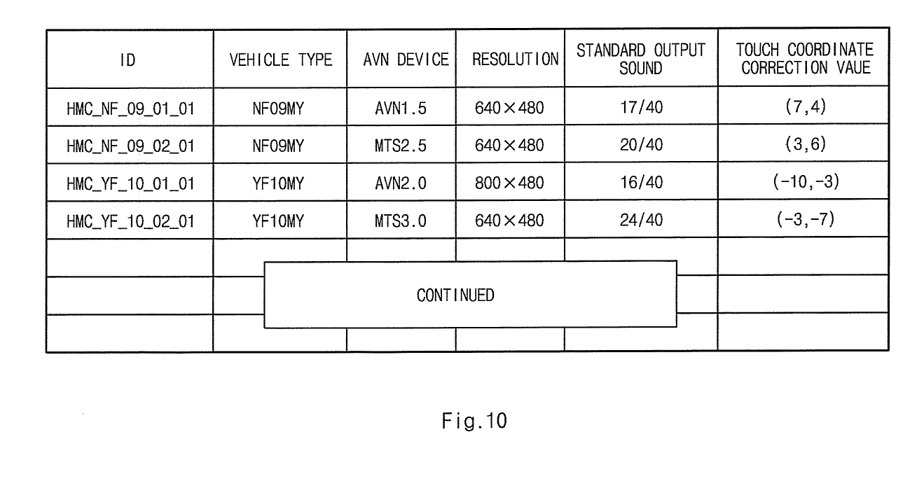

In other exemplary embodiments, FIG. 9, for example, is a diagram exemplifying an ID of a portable device that is set in an AV terminal, and FIG. 10 is a diagram illustrating the settings for each ID of a portable device that is stored in a portable device according to an embodiment of the present invention.

As shown in FIG. 9, an ID of a portable device may preferably be set in the AV terminal according to an embodiment of the present invention. For example, in one exemplary embodiment, in the case of an ID “HMC_YF_{—}10_{—}02_{—}01”, “HMC” indicates a company name, “YF” indicates a vehicle type, “10” indicates year, “02” indicates a system type, and “01” indicates a software version.

Preferably, the AV terminal according to an exemplary embodiment of the present invention, e.g., the AVN, connects with a portable device for each vehicle type/AVN device, and then suitably transmits the ID to the portable device.

For example, FIG. 10 shows the contents of the settings for each ID stored in the portable device 200 according to an exemplary embodiment of the present invention. The particulars of the settings may be an image transmission state according to resolution, sound transmission default setting, and touch coordinate basis according to a touch coordinate correction value. For example, in certain preferred embodiments, an ID, a vehicle type, an AVN device, resolution, standard output sound, touch coordinate correction value, and the like may be set in the portable device according to the contents of ID stored in the DB.

Consequently, according to the car AV terminal system with a user interface linkable with a portable device and the method of linking the same according to certain embodiments of the present invention, the same user interface as that including an external appearance of a portable device and a user interface of the portable device can be implemented in a car AV terminal. Preferably, it is not required to change the user interface and key arrangement in an AV terminal for respective multimedia devices, and it is not required to establish separate protocols for respective multimedia devices/functions.

The above description, such as the detailed construction and elements are merely exemplary, and thus it should be understood that various modifications thereof are possible to those of ordinary skill in the art to which the invention pertains without changing the technical thought or essential features of the invention. Accordingly, the present invention is not limited to the embodiments as disclosed above, but can be implemented in diverse forms.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A car audio/video (AV) terminal system having a user interface linkable with a portable device connected to the system, comprising:
an AV terminal connected to the portable device for receiving a portable device image from the portable device, outputting the portable device image to an AV screen, transmitting a touch manipulation value to the portable device if a user touches the AV screen, outputting an image corresponding to the operation of the portable device to the AV screen, and outputting sound corresponding to the operation of the portable device to a speaker provided in a vehicle; and
a portable device connected to the AV terminal through a wired/wireless interface for analyzing the touch manipulation value transmitted from the AV terminal to operate accordingly and transmitting the sound and the image corresponding to the operation of the portable device to the AV terminal;
wherein the image output from the portable device includes a shape of an external appearance of the portable device, and the AV terminal implements the user interface corresponding to the external appearance of the portable device on the AV screen.

2. The car AV terminal system of claim 1, wherein the AV terminal comprises:
a touch screen displaying the AV screen of the AV terminal and executing the touch manipulation;
a mode setting unit setting an operation mode of the AV terminal;
a data processing unit converting the sound and the image transmitted from the portable device into a form that matches the AV terminal; and
a memory storing ID information that corresponds to the device name of the AV terminal.

3. The car AV terminal system of claim 2, wherein the AV terminal further comprises a vibration generating unit operating vibration feedback by operating a motor when the user performs the touch manipulation.

4. The car AV terminal system of claim 1, wherein the AV terminal automatically enters into a portable device mode when the AV terminal is connected to the portable device.

5. The car AV terminal system of claim 1, wherein the AV terminal transmits ID information that corresponds to the device name of the AV terminal to the portable device.

6. The car AV terminal system of claim 5, wherein the portable device comprises a database (DB) searching for a set value that corresponds to the ID information of the AV terminal.

7. The car AV terminal system of claim 6, wherein the ID information includes a company name, a vehicle type, year, a system type, or software version, and the set value may include resolution of the AV terminal, a standard output sound, or a touch coordinate correction value.

8. A method for linking a user interface of a vehicle audio/video (AV) terminal with a portable device, comprising the steps of:
to a) operating an AV terminal for a vehicle and connecting the AV terminal with a portable device;
b) outputting an image of an external appearance of the portable device by the portable device;
c) outputting the portable device image to an AV screen by the AV terminal;
d) touching the AV screen by a user and transmitting a touch manipulation value from the AV terminal to the portable device;
e) analyzing the transmitted touch manipulation value by the portable device and operating the portable device accordingly;
f) transmitting sound and an image corresponding to the operation of the portable device to the AV terminal by the portable device; and
g) outputting the transmitted portable device image to the AV screen by the AV terminal and outputting the transmitted portable device sound through a speaker.

9. The method of claim 8, wherein if the AV terminal is connected with the portable device in the step a), the AV terminal automatically enters into a portable device mode.

10. The method of claim 8, wherein in the step b), the image of the external appearance of the portable device output by the portable device includes buttons of the portable device.

11. The method of claim 8, wherein in the step c), the AV terminal transmits ID information that corresponds to a device name of the AV terminal to the portable device.

12. The method of claim 11, wherein the portable device searches for a set value that corresponds to the ID information of the AV terminal in a database (DB).

13. The method of claim 12, wherein the ID information is selected from a company name, a vehicle type, year, a system type, or software version, and the set value may include resolution of the AV terminal, a standard output sound, or a touch coordinate correction value.

14. The method of claim 8, wherein in the step d), the AV terminal operates vibration feedback by operating a motor when the user performs the touch manipulation.

15. The method of claim 8, wherein the steps b) to g) are repeatedly performed.

16. A car audio/video (AV) terminal system having a user interface linkable with a portable device connected to the system, comprising:
an AV terminal connected to the portable device for receiving a portable device image from the portable device; and
a wired/wireless interface that connects the portable device to the AV terminal,
wherein the image output from the portable device includes a shape of an external appearance of the portable device, and the AV terminal implements a user interface corresponding to the external appearance of the portable device on the AV screen.

17. The car audio/video (AV) terminal system according to claim 16, wherein the AV terminal outputs the portable device image to an AV screen, transmits a touch manipulation value to the portable device if a user touches the AV screen, outputs an image corresponding to the operation of the portable device to the AV screen, and outputs a sound corresponding to the operation of the portable device to a speaker provided in a vehicle.

18. The car audio/video (AV) terminal system according to claim 16, wherein the portable device connected to the AV terminal through the wired/wireless interface is used for analyzing the touch manipulation value transmitted from the AV terminal in order to operate accordingly and transmitting the sound and the image corresponding to the operation of the portable device to the AV terminal.
